(19) United States
(12) Patent Application Publication
(10) Pub. No.: US 2009/0104416 A1
(43) Pub. Date: Apr. 23, 2009

(54) DECORATED FABRIC FOR AUTOMOTIVE USE

(76) Inventor: Jung Soon Chang, Glendale, CA (US)

Correspondence Address: PARK LAW FIRM, 3255 WILSHIRE BLVD, SUITE 1110, LOS ANGELES, CA, 90010, US

(21) Appl. No.: 11/875,379

(22) Filed: Oct. 19, 2007

(51) Int. Cl. B44F 3/00

(52) U.S. Cl. 428/196

(57) ABSTRACT

A decorative fabric for automotive use includes a fabric piece that is attached to a predetermined location of an automobile and a plurality of discrete decorative pieces that are attached to predetermined positions, which forms a desired pattern, on the fabric piece. Each of the decorative pieces comprises a hard outer piece that has a predetermined shape, and a heat-curing adhesive layer that fixes the hard outer piece to the fabric piece. The hard outer piece includes a metal stud and an artificial gem stone.

### BACKGROUND OF THE INVENTION

The present invention relates to a decorated fabric for automotive use. More particularly, the present invention relates automotive fabric products having metal and artificial gemstone stud decorations integrated thereto.

Fabrics are used in many places in automobile including seat covers and floor mats. While commercial value of automobile fabric products may be greatly enhanced by providing decoration thereto, strict requirements including strength, anti-weathering ability, and manufacturing cost, which are required for automotive parts have limited adding decorations to automotive fabric parts.

There has long been a need for durable and viable decoration method for automotive fabric parts, and parts manufactured using such method.

### SUMMARY OF THE INVENTION

The present invention contrives to solve the disadvantages of the prior art.

An objective of the invention is to provide a decorative fabric product for automobile.

Another objective of the invention is to provide a automotive fabric products incorporating artificial gemstone or metal studs.

In order to achieve the above objective, the present invention provides a decorative fabric for automotive use that includes a fabric piece that is adapted to be attached to a predetermined location of an automobile and a plurality of discrete decorative pieces that are attached to predetermined positions on the fabric piece. Each of the decorative pieces comprises a hard outer piece that has a predetermined shape, and an adhesive layer that are adapted to be fix the hard outer piece to the fabric piece.

The adhesive layer comprises a glue that is cured at about 390 degree Celsius.

Alternatively, the adhesive layer is adapted to be cured at a temperature range from about 150 degree Fahrenheit to about 190 degree Fahrenheit. Preferably, the adhesive layer is adapted to be cured at about 180 degree Fahrenheit.

The hard outer piece comprises a metal stud.

Preferably, the metal stud is made of aluminum.

In another embodiment, the hard outer piece comprises an artificial gem stone. The artificial gem stone is made of glass or plastic resin.

The decorative fabric may include a seat cover, a floor mat, a steering wheel cover or a dashboard cover.

The plurality of discrete decorative pieces form a predetermined pattern with the predetermined positions on the fabric piece.

The advantages of the present invention are: (1) various existing decoration effects can be applied to automotive fabric products; (2) manufacturing cost is reduced by applying various combinations of metal studs and artificial gem stone decorations; and (3) adding decoration effect is facilitated with simple heat curing process.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of a seat cover according to the present invention;

FIG. 2 is a perspective view of a floor mat according to the present invention;

FIG. 3 is a cross-sectional view of an artificial gem stone;

FIG. 4 is a cross-sectional view of a nail head;

FIG. 5 is a perspective view of an artificial gem stone;

FIG. 6 is a perspective view of a nail head; and

FIG. 7 is a perspective view of an artificial pearl.

### DETAILED DESCRIPTION OF THE INVENTION

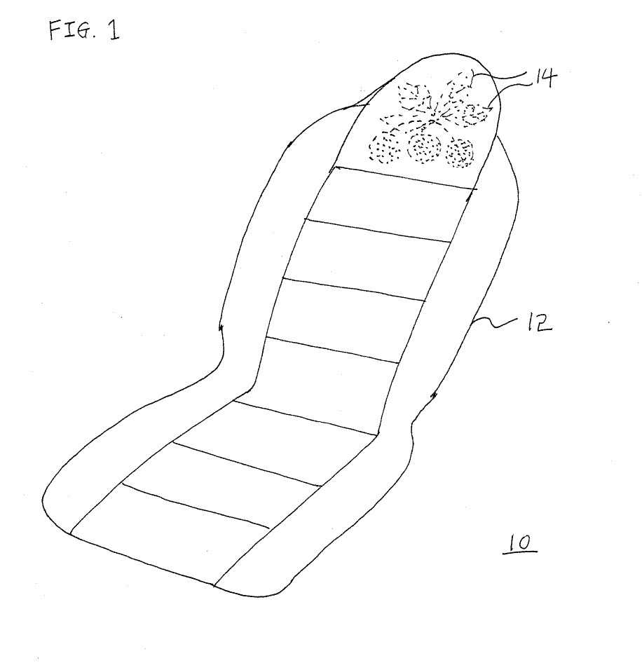

FIG. 1 shows a decorative fabric 10 for automotive use that includes a fabric piece 12 that is adapted to be attached to a predetermined location of an automobile and a plurality of discrete decorative pieces 14 that are attached to predetermined positions on the fabric piece 12. In the example shown in FIG. 1, the fabric piece is a seat cover. FIG. 2 shows another example, in which the fabric piece is a floor mat 15.

FIG. 3 shows that each of the decorative pieces 14 comprises a hard outer piece 16 that has a predetermined shape, and an adhesive layer 18 that are adapted to be fix the hard outer piece 16 to the fabric piece 12.

The adhesive layer comprises a glue that is cured at about 390 degree Celsius.

Alternatively, the adhesive layer is adapted to be cured at a temperature range from about 150 degree Fahrenheit to about 190 degree Fahrenheit. Preferably, the adhesive layer is adapted to be cured at about 180 degree Fahrenheit.

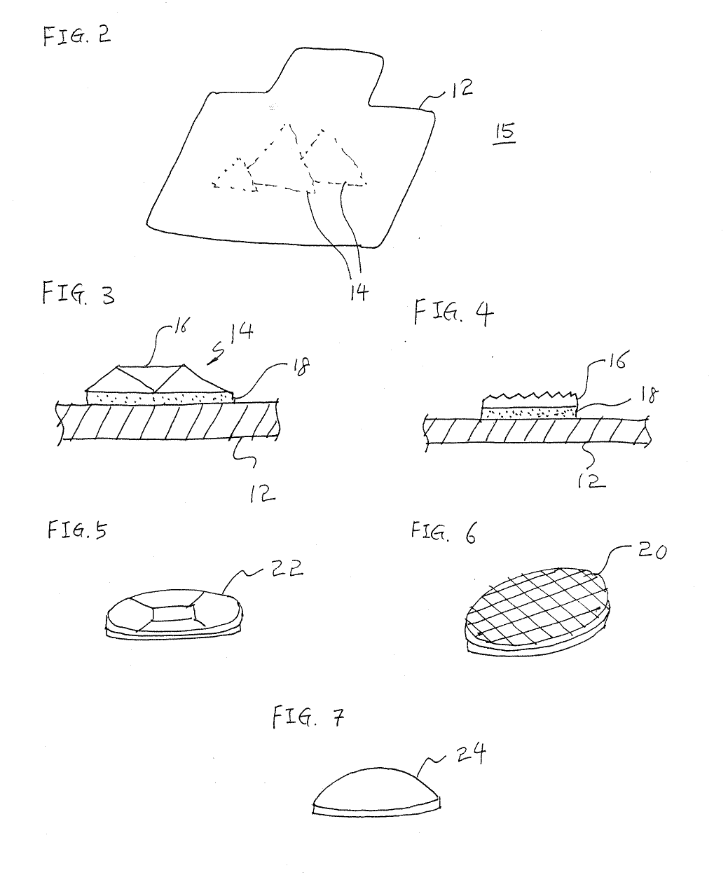

FIGS. 4 and 6 show that the hard outer piece 16 comprises a metal stud 20. Preferably, the metal stud 20 is made of aluminum.

FIGS. 3 and 5 show that the hard outer piece 16 comprises an artificial gem stone 22. The artificial gem stone 22 is made of glass or plastic resin.

FIG. 7 shows that the hard outer piece 16 comprises an artificial pearl 24.

The decorative fabric 10 may include a seat cover, a floor mat, a steering wheel cover or a dashboard cover.

The plurality of discrete decorative pieces 14 form a predetermined pattern with the predetermined positions on the fabric piece 12.

Fabric products for automotive use are generally thick and have irregular shape. Other materials like leather are also widely used for automotive interior facilities. The present invention provides method and product that are suited to such automotive products.

The application of the decorative fabric 10 of the present invention includes seat cover, shoulder pad, floor mat, steering wheel cover, dashboard cover, organizer and sun shade, etc.

The hard outer piece 16 includes many commercially available products including rhinestone & stud, nail head, pearls, pet spangels, nice rims, glitters, epoxy studs, convex metal hotfix and cabochons, which are provided by MOMO Co. Ltd.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A decorative fabric for automotive use comprising:
a) a fabric piece that is adapted to be attached to a predetermined location of an automobile; and
b) a plurality of discrete decorative pieces that are attached to predetermined positions on the fabric piece;
wherein each of the decorative pieces comprises a hard outer piece that has a predetermined shape, and an adhesive layer that are adapted to be fix the hard outer piece to the fabric piece.

2. The decorative fabric of claim 1, wherein the adhesive layer comprises a glue that is cured at about 390 degree Celsius.

3. The decorative fabric of claim 1, wherein the adhesive layer is adapted to be cured at a temperature range from about 150 degree Fahrenheit to about 190 degree Fahrenheit.

4. The decorative fabric of claim 3, wherein the adhesive layer is adapted to be cured at about 180 degree Fahrenheit.

5. The decorative fabric of claim 1, wherein the hard outer piece comprises a metal stud.

6. The decorative fabric of claim 5, wherein the metal stud is made of aluminum.

7. The decorative fabric of claim 1, wherein the hard outer piece comprises an artificial gem stone.

8. The decorative fabric of claim 7, wherein the artificial gem stone is made of glass.

9. The decorative fabric of claim 7, wherein the artificial gem stone is made of plastic resin.

10. The decorative fabric of claim 1, wherein the decorative fabric comprises a seat cover.

11. The decorative fabric of claim 1, wherein the decorative fabric comprises a floor mat.

12. The decorative fabric of claim 1, wherein the decorative fabric comprises a steering wheel cover.

13. The decorative fabric of claim 1, wherein the decorative fabric comprises a dashboard cover.

14. The decorative fabric of claim 1, wherein the plurality of discrete decorative pieces form a predetermined pattern with the predetermined positions on the fabric piece.
